(19) United States
(12) Patent Application Publication
(10) Pub. No.: US 2013/0325150 A1
(43) Pub. Date: Dec. 5, 2013

(54) Method for the Operation of a Control Unit and a Control Unit

(71) Applicant: Henryk Bury, Loehne (DE)

(72) Inventor: Henryk Bury, Loehne (DE)

(21) Appl. No.: 13/905,241

(22) Filed: May 30, 2013

(30) Foreign Application Priority Data
Jun. 5, 2012 (DE) 10 2012 011 040.5

(51) Int. Cl. G05B 13/02

(52) U.S. Cl. CPC G05B 13/02
USPC 700/40

(57) ABSTRACT

At least one electrical device with a control unit can be operated in a recording mode and an operating mode. In the recording mode, the point in time and the form in which the at least one electrical device is operated are recorded. Corresponding operating data are provided and saved with the time data corresponding to the point in time. The time data lie within a memory time interval. A switch point is recorded at which the control unit is switched from the recording mode to the operating mode, and a changeover point within the memory time interval is assigned to this switch point. In the operating mode, the saved operation data and time data are read and the at least one electrical device is operated, dependent on the saved operation data and time data starting at the changeover point.

The invention refers to a method for the operation of a control unit for at least one electrical device, as well as a control unit for at least one electrical device.

Examples of electrical devices for which this type of control units are frequently used are lamps and electric blinds. Of course, such control units can also be utilized for any other electrical device.

In particular the effect of lighting devices, such as outdoor lamps, outdoor blinds and similar electrical devices is that it can be seen from the outside of a building if and when the electrical device is being used or operated. Should the owner of a detached house go on holiday for a period of time, for example, or for other reasons is absent for an extended period, the outer blinds for example are not activated during this time, so that it is easily recognisable from the outside that the property concerned is empty. This consequently increases the risk of burglary or of someone breaking in, as the thief can see from the outside that they are not likely to be disturbed. It is therefore known to enable these electrical devices in particular to be programmed in such a way that they can be operated automatically during the absence of the person operating the device. In this way, it is known from the prior art to programme electric outer blinds, for example, so that they are always lowered and raised at certain times of day.

However, this does have the disadvantage that these types of devices have to be programmed prior to usage, which is complex. The individual times at which the devices should be switched on and off are entered into the device or the control unit of the device in this manner.

In addition, the programmed times at which the electrical devices should be operated must be individually adjusted to the time of absence; for example, in winter outer blinds are normally closed for a considerably longer time during the day than in summer. This means that, in order to maintain the effect from outside that the property owner is present, the control unit has to be programmed differently for a summer holiday than for a winter holiday. This is also complicated and not very convenient.

It is known from the prior art that particularly outer blinds are left to react to the lighting conditions. However, this is of course only possible for electrical devices whose operation is linked with the incidence of light or brightness.

The invention therefore aims to propose a method for the operation of such a control unit and a control unit for at least one electrical device with which the disadvantages from the prior art can be rectified.

The invention solves the problem at hand by means of a method for the operation of a control unit for at least one electrical device, wherein the control unit can be operated in a recording mode and an operating mode. In the recording mode, the point in time at which the at least one electrical device is operated is recorded and time data corresponding with the point in time are associated and saved, wherein the time data lie within a memory time interval. In addition, a switch time point is recorded at which the control unit is switched from the recording mode to the operating mode. Corresponding time data, in the following referred to as the changeover time point, are also assigned to this switch time point. The changeover time point also lies within the memory time interval. In the operating mode, the saved operation data and time data are read and the at least one electrical device goes into operation, dependent on the saved operation data and time data starting at the changeover time point.

The control unit is then predominantly operated in a recording mode. In this mode, operation data are saved with associated time data, so it can be seen afterwards when the electrical device was used. It is therefore also recorded at which point in time the device is used and this point is saved in the form of corresponding time data with the operation data corresponding to the type of operation.

Operation data may include the fact of switching on and off of the at least one electrical device, or an operation carried out in a different way. In this way, it is conceivable with outer blinds, for example, that they are not fully lowered, but instead only partially cover a window in order to retain any incoming sunlight and maintain a basic brightness inside the room. This recording of the operation data with the associated time data, from which it can be reconstructed when the respective operation took place, is preferably continued over a memory time interval. This can be a week, a time, a month or another suitable time frame. Within the memory time interval, every operation of the at least one electrical device is consequently provided with associated time data and saved.

Should the control unit now be switched from the recording mode to the operation mode, a changeover time point within the memory time interval is assigned to the switch time point at which this switch occurs. From this moment onwards, the control unit runs in the operating mode, so that the saved control data and time data are read from the memory device. The electrical device is operated according to these saved operation and time data, the operation starting with the operation data which show the time data following the changeover time point. Therefore, the electrical device is not generally initially operated dependent on the operation data which occur at the beginning of the memory time interval.

An internal clock is preferably located inside the control unit, which can be designed as a cycle counter, for example. Alternatively it is also possible to provide an electric control system that is constantly connected to an external clock, for example via a satellite system such as GPS, to attain the current time. As soon as the control unit is put into operation for the first time in the recording mode, the memory time interval starts running. It is thereby irrelevant for the functioning of the method according to the invention at which exact time or on which date or weekday this occurs. Should an internal clock be provided in the control unit, this initially runs through the memory time interval. Should the clock reach the end of this interval, it starts again from the beginning so that every point in time, consisting of a date and a time for example, can be assigned to a point within the memory time interval.

As soon as the control unit is switched from the recording mode to the operating mode, a changeover time point is assigned to this switch time point. From this moment onwards, the consequent operating data and time data are read and the at least one electrical device is run correspondingly.

By means of the method according to the invention, the at least one electrical device is run fully automatically when the control unit is in the operating mode. In particular when used for outer blinds or lighting devices, the impression can be maintained that a resident of the respective building or apartment is present. However, complex programming is not necessary, as the daily operation of the relevant electrical device occurs in the recording mode.

In an especially preferable configuration of the method, the memory time interval is repeated when in the operating mode and the at least one electrical device runs repeatedly, dependent on the saved operation and time data. Should the length of the memory time interval equal one week, for example, but the owner of a residence is on holiday for 3 weeks, the memory time interval repeats 3 times and the respective electrical device, such as the outer blinds, is operated correspondingly. The control unit begins operation at the switch time point of the at least one device. It does not commence with the operation according to the data saved at the beginning of the memory time interval, unless the switch coincidentally occurs at this point in time.

It has also been proven to be advantageous if, in the recording mode, saved operating and time data are overwritten with further operating and assigned time data if the length of time during which the control unit is run in the recording mode is longer than the length of the memory time interval. Should the length of the memory time interval equal one week, for example, the operating and associated time data are saved in the first week during which the control unit runs in the recording mode. In the second week, the operating data recorded in the first are overwritten with operating data from the second week. This ensures that the most current operating data possible are saved in the memory device whenever the control unit is switched from the recording mode to the operating mode. In particular, if the operation of the at least one electrical device is dependent on the amount of daylight available, as is the case with outer blinds for example, this function ensures that differently programmed control units don't have to be provided for summer and winter holidays. The most current operating data are always used with the relative time data. Alternatively it is of course also possible to save the respective operating and associated time data only once over the length of a memory time interval and to save no further operating data once the control unit has run in the recording mode for the length of one memory time interval.

It has been proven to be advantageous if the length of the memory time interval is adjustable in order to meet different requirements.

With some electrical devices that are operated by a control unit, which can be driven by the method described here, it is necessary for the operation to always occur at precisely the same time. With other electrical devices, such as outer blinds, an overly exact reproduction can ruin the desired impression that the resident is present. It is unlikely, for example, that outer blinds are activated at exactly the same time every day. However, should the length of the memory time interval equal one day, for example, this would be exactly the outcome. Therefore it can be advantageous if, for the operation of the electrical device according to the operating and time data, the operation does not occur at the exact time of the saved time data, but rather at times that have been slightly shifted and adjusted. If the lowering of the outer blind has been recorded at an exact time, for example, this function of the method in the operating mode allows the outer blinds to be lowered at a time offset by five to ten minutes. The length of the time interval by which the operation is offset can be pre-set, computer generated or randomly selected.

Additionally it is possible to link the actual operation of the at least one electrical device in the operating mode of the control unit to external influences. This is particularly conceivable for the operation of electric shutters oder lights, for example, which may be controlled dependent on the respective sunrise and/or sunset. It is conceivable, for example, that an electric control system recognises a correlation between the operating and time data recorded by the control unit in the recording mode and the respective sunrise and/or sunset, and, with this recognised correlation, generates the operation of the at least one electrical device when the control unit is in the operating mode. Should the control unit be run in the operating mode over a longer period of time, for example, because the property owner is absent for several months, it is possible that several months pass between the last recording of operating and time data in the recording mode and the current reproduction. Should a light source always be switched shortly after sunset, for example, this would happen considerably earlier in the day in February then in June or July. If a control unit as described here simulates the presence of the property owner, the movement of the sunrise or sunset significantly influence the quality of this simulation, because the control unit in the operating mode might activate the electric lighting in a house in June or July at 5 pm, for example, as the control unit was last used in the recording mode in February. This can be prevented by adjusting it to the sunrise and sunset times.

Should the control unit also be provided with data about special days in the calendar, such as public holidays, these can also be taken into account. In this way, this type of control unit in the operating mode could ensure that if a public holiday is recognized, for example, the electric blinds are opened later on the respective day than on normal work days. Furthermore, this considerably improves the simulation of the presence of the property owner. The same goes for the use of holiday dates or other such specifics.

Correlations between different operating processes, which were recorded when the control device was in recording mode, can also be used for the operation of the at least one electrical device when the control unit is in the operating mode. Should the electric control system recognise, for example, that an electrical device such as a light is always switched on between 6 pm and 6.30 pm, it can provide time data that are randomly selected within a corresponding time interval for the operation of the device in the operating mode, rather than exactly reproducing the operating data. For the selection of corresponding time data, a huge variety of algorithms could be used.

The control unit preferably comprises several control elements with which preferably several electrical devices can be operated. In this case, it is for example advantageous to save operating data from the recording mode of the control unit in separate memory devices. This renders a retrofitting of existing control units particularly simple.

In an especially preferred configuration of the method, the control unit is arranged in such a way that it can be switched separately to the recording mode and/or operating mode for each electrical device that is to be operated. In this way, electrical devices that are not used whilst the owner is on holiday, for example, can be run with the same control unit as devices that should be operated whilst the owner is not present. The device that are not to be used are thus not switched to the operating mode.

A control unit according to the invention for at least one electrical device comprises at least one control element for the operation of the at least one electrical device and an electric control system that is configured to carry out the above method. A control element may refer to a switch, such as a toggle or pressure switch, a lever or a rotary switch, or another type of control element. The electric control system preferably includes at least one memory element in which the operating and time data to be saved can be stored. If the control unit only initially runs in the recording mode for a period of time that is shorter than the length of the memory time interval, the pre-existing notional operating data in the memory element are preferably consigned to time data. Otherwise the control element would have no possibility to save operating data with time data over the entire duration of the memory time interval. In addition, the assignment between the current time and the point in time within the memory time interval is preferably adjustable. As a result the control unit can maintain operation following, for example, a power cut which prevented the control unit from working for a certain time, without having to wait for the entire duration of the memory time interval to collect operating data with associated time data across this whole duration.

For a unit according to the invention it is irrelevant at which actual point in time, such as at what time, the memory time interval begins and at which point in time the unit is operated in the recording mode for the first time. Should the length of the memory time interval equal one week, for example, it is irrelevant for the unit on which weekday the memory time interval begins. Provided that the unit is in the recording mode, it records when the electrical device is used for the duration of the memory time interval, in this case for one week. As long as the unit is operated in the recording mode for at least the duration of the memory time interval, it consequently records operating data with corresponding time data over the entire duration of the time interval. Should the unit be switched from the recording mode to the operating mode, a changeover time point within the memory time interval is assigned to this switch time point. For example, this can be on the third day of a week long recording time interval. From this moment on, the unit is thus run in the operating mode. In this case, for the operation of the at least electrical device, the operating and time data are used that were recorded while the unit was in recording mode. However, the unit does not commence operation at the beginning of the memory time interval, but at the changeover time point.

Should an error now occur in the power supply to the unit, such as a power cut, the fixed assignment between a point in time within the memory time interval and the actual time is lost. This can be recovered by means of the preferably adjustable assignment between the current point in time, i.e. the actual time, and the point in time within the memory time interval. Otherwise it could occur that the at least one electrical device is operated one morning, dependent on the operating and time data recorded one evening. Should the at least one electrical device refer to a light source, for example, the desired function of the unit would therefore no longer be achievable. In order to prevent this, complete sets of data saved in the memory time interval would have to be ignored and replaced by a new recording, for which the unit would have to be operated in the recording mode.

The control device preferably comprises several control elements whose operating data is saved if the control unit is operated in the recording mode. These several control elements are preferably designed to operate several electrical devices. It is advantageous if a memory device is assigned to each control element to save the operating data of the respective control element and the associated time data.

This type of control unit can comprise light switches for lamps in different rooms of a house, for example. In this case it is an advantage if a separate memory device is assigned to each control element, i.e. each light switch, the memory device particularly preferably being arranged in the spatial proximity to the light switch. This allows existing houses to also be easily equipped with a corresponding control unit. In addition, it is an advantage if a switch element is arranged on each control element by means of which the control unit can be switched from the recording mode to the operating mode, and vice-versa. As a result, when several light switches are used for various light sources, the control unit for each light switch can be switched from the recording mode to the operating mode, and vice-versa. This can be a pressure switch, for example, that may be arranged next to the light switch or integrated into the actual light switch.

In a particularly preferable arrangement of the control unit, a transmission device and a reception device are assigned to each control element for transmitting and receiving signals from one control element about the switch from the recording mode to the operating mode, and vice-versa, to all other control elements or to a central control system, if available, which transfers the signal to other control units or operates the other electrical devices. As a result, it is possible to send wireless signals from one control element, such as a light switch, to the other light switches used in the house. A central unit is therefore no longer necessary in which, for example, all operating data are saved or which centrally monitors the switch of the control unit.

A control unit additionally comprises a signaling device which indicates whether the control unit is in the recording mode or the operating mode. For example, this can be an LED or another transmission device for sending optic signals, which is arranged in, on, or close to a control element, for example. In this way it is conceivable to provide a pressure switch inside a light switch, which is part of the control unit that is configured to light up, for example, when the control unit is in the operating mode.

With the aid of a drawing an embodiment of the present invention will be explained in more detail. What is shown is:

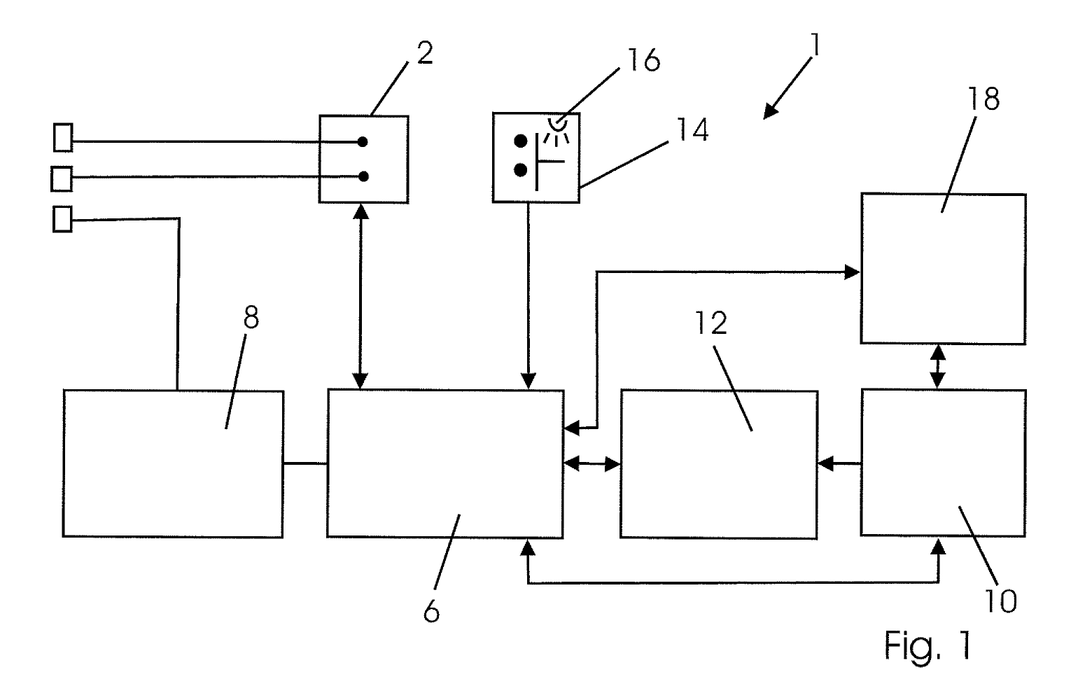

FIG. 1—a block diagram of a control unit according to a first embodiment of the present invention,

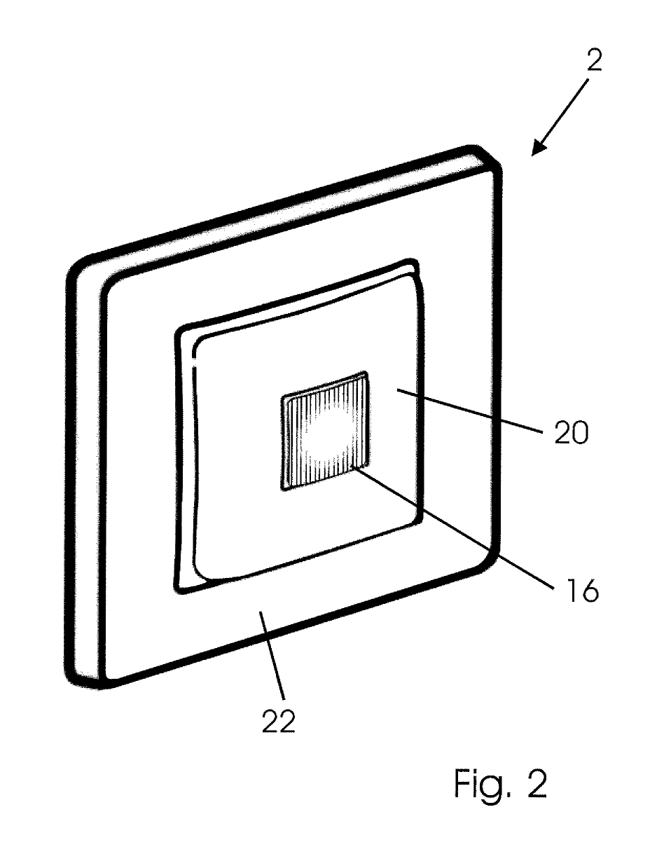

FIG. 2—a control element of a control device in the operating mode,

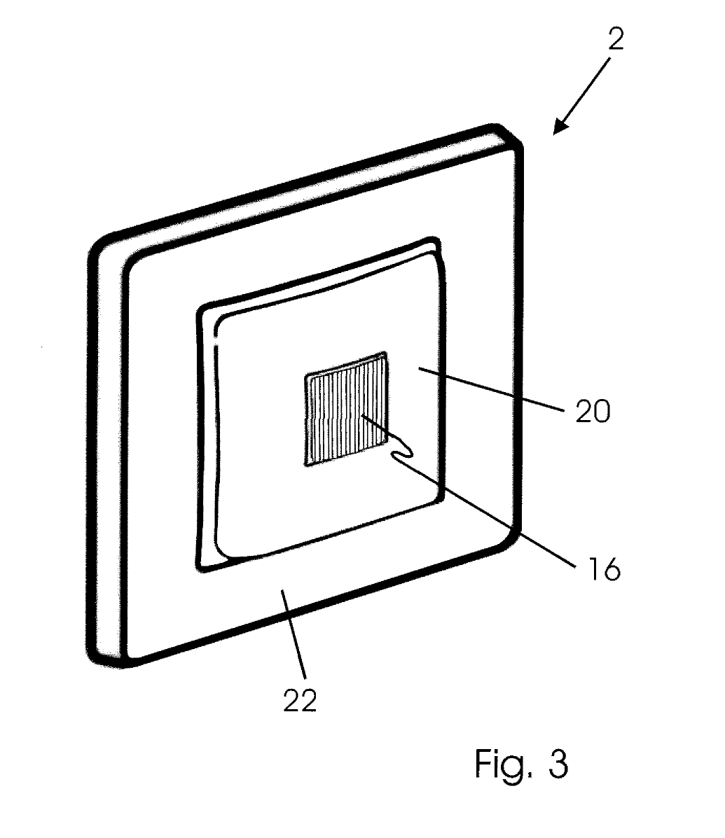

FIG. 3—a control element of a control device in the recording mode,

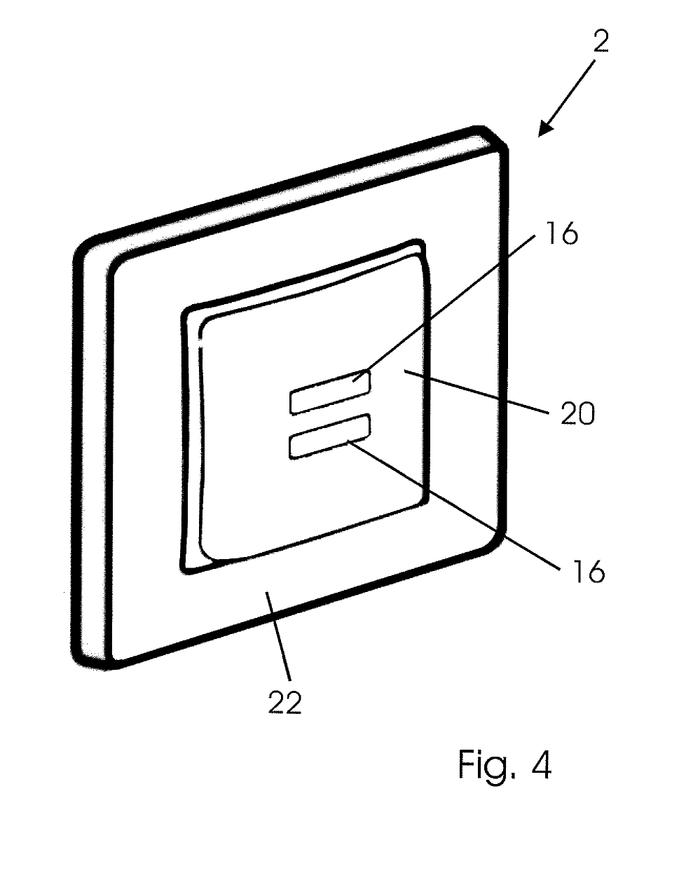

FIG. 4—a further control element for a control unit according to an embodiment of the present invention,

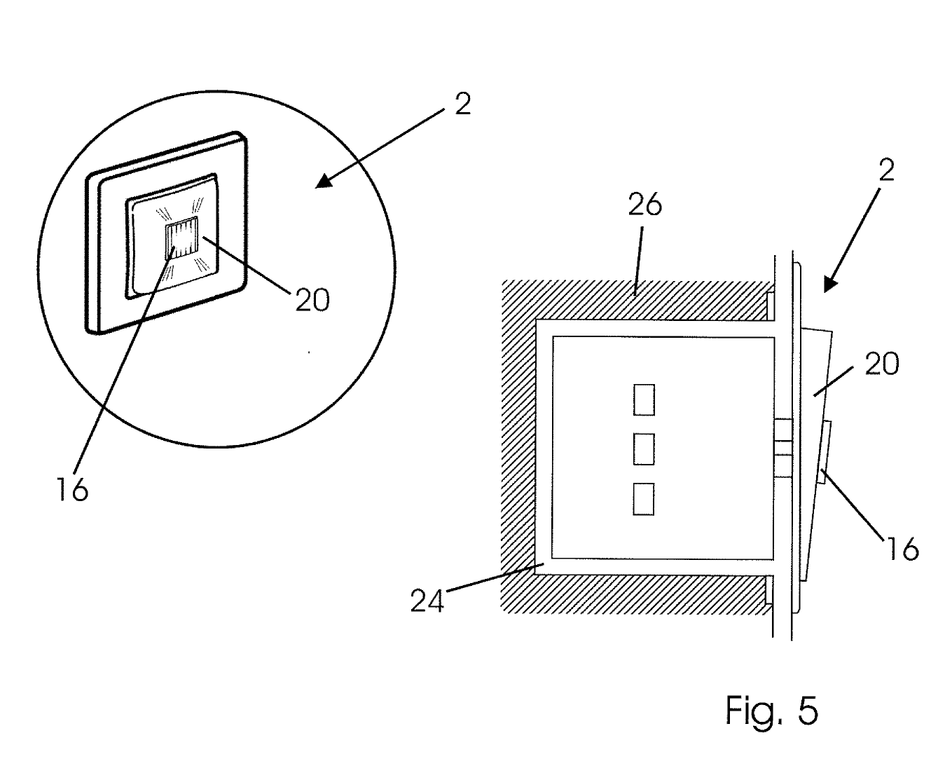

FIG. 5—a control element in a schematic 3D view and a sectional view,

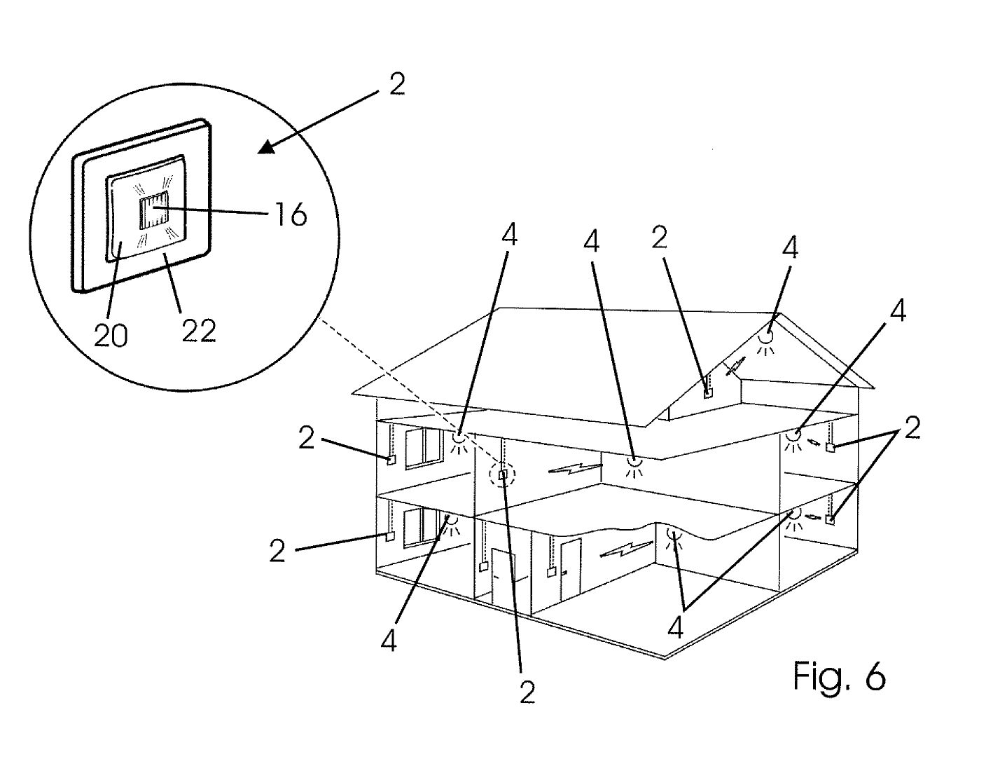

FIG. 6—a house equipped with a control unit according to an embodiment of the present invention, as well as

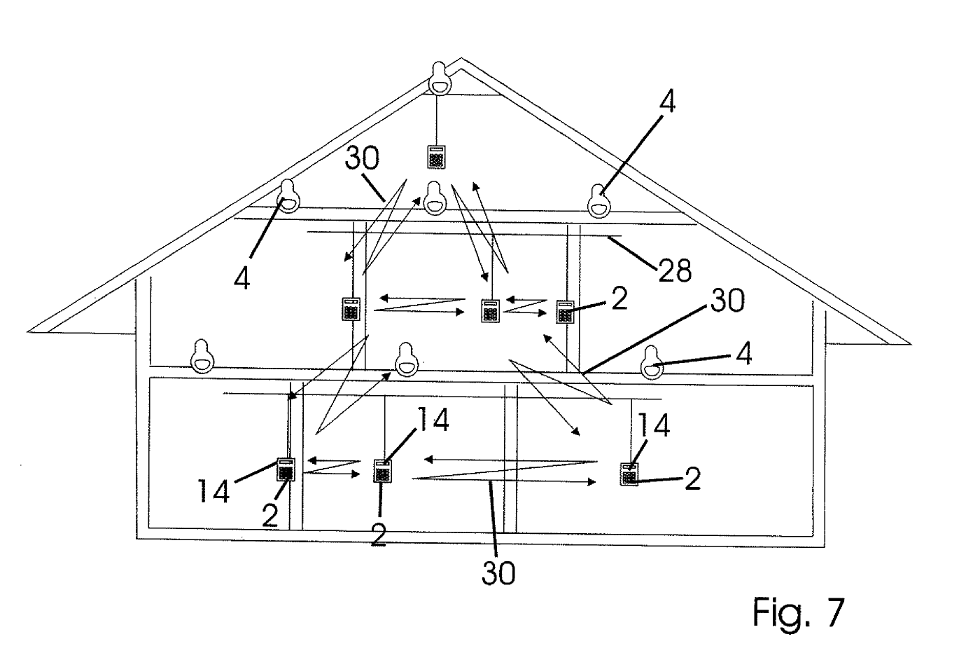

FIG. 7—the schematic sectional view of a house equipped with a control unit according to a further embodiment of the present invention.

FIG. 1 shows a block diagram of a control unit 1 according to an embodiment of the present invention. It comprises a control element 2, which is realised by a light switch in FIG. 1. This operates an electrical device 4, not depicted in FIG. 1.

If the control unit 1 is in the recording mode, operating data are transmitted from the control element 2 to an electric control system. This comprises a power supply 8. In the embodiment shown in FIG. 1, the control unit 1 comprises an internal clock 10. The electric control unit 6 can communicate with this clock, so that the operating data transmitted from the control element 2 to the electric control system 6 can be assigned with corresponding time data. The operating data are saved in a memory device 12 with the associated time data.

The control unit 1 comprises a switch element 14 by means of which the control unit 1 can be switched from the recording mode to the operating mode and vice-versa. A light emitting diode 16 is located in the switch element 14 which can indicate which mode the control unit 1 is currently being operated in.

Should the control unit 1 not run in the recording mode, the light emitting diode 16 can, for example, be unlit. Should the clock 10 run through the memory time interval, it begins again at the start of the memory time interval. New operating data that are sent to the electric control system 6 by operating the control unit 2 are saved in the memory device 12 and already available data are overwritten.

Should the control unit 1 now be switched by the switch element 14 from the recording mode to the operating mode, the light emitting diode 16 begins to light up. A switch signal is sent from the switch element 14 to the electric control system 6, which assigns a changeover time point within the memory time interval via the clock 10. From this moment onwards, operating data are now longer saved in the memory device 12, but rather are read from it. By comparing the saved time data in the memory device 12 with the current time of the internal clock 10, it can be determined at which point in time the control element 2 must be activated to operate the non-depicted electrical device.

Switch signals from the switch element 14, with which the control unit 1 is switched from the recording mode to the operating mode or vice-versa, are transmitted from the electric control system 6 to a transmission and reception device 18. This transmits a corresponding signal to other transmission and reception devices of other control units 1 or other parts of the same control unit 1, in order to also be able to operate other control elements 2 by the respective electric control system 6.

FIG. 2 shows a control element 2 that is constructed as a light switch. It comprises a rocker 20 that is provided to operate the non-depicted electrical device 4. A light emitting diode 16, depicted in the lit state in FIG. 2, is located in the middle of the rocker 20, so that it is in the operating mode in the embodiment of the control unit 1. As with conventional light switches, the rocker 20 is also enclosed by a covering 22.

FIG. 3 shows the depiction from FIG. 2, wherein the light emitting diode 16 is now in the unlit state, so that the control unit is operated in the recording mode.

FIG. 4 shows an alternative arrangement of a control element 2 with two light emitting diodes 16 that can indicate whether the control unit 1 is in the recording mode or operating mode.

The left-hand section in FIG. 5 once again shows the control element 2 with the rocker 20 and the lit LED 16. The right-hand section shows that the control element 2 comprises a flush mount box 24 that is mounted in a wall 26. The flush mount box 24 preferably has the same dimensions as conventional flush mount boxes, so that existing buildings can be easily equipped with a control unit 1 with these type of control elements 2.

In the left-hand area of FIG. 6 once again shows the control element from FIG. 5, which is arranged in the house shown in the right-hand part. Different rooms can be recognised, in each of which a control element 2 is provided. The control elements 2 are all designed as light switches which can be operated by the electrical devices 4. These are lamps arranged in the individual rooms of the building shown.

FIG. 7 shows a schematic sectional view through this type of building. The individual control elements 2 for the operation of the electrical devices 4 are connected with the electrical devices 4 via power connections, so that the devices 4 can be operated by the control elements 2. The jagged double arrows depict that the individual control elements 2 comprise the transmission and reception devices 18, allowing them to establish contact with each other. A switch element is provided on each control element 2 with which the control unit 1 can be switched from the recording mode to the operating mode. As soon as this happens with one of the control elements 2, signals are sent via the transmission and reception device of this control element 2 and received by the remaining control elements 2, so that these can also be switched to the respective new mode.

### REFERENCE NUMERALS

1 Control unit
2 Control element
3 Electrical device
6 Electric control system
8 Power supply
10 Clock
12 Memory device
14 Switch element
16 Light emitting diode
18 Transmission and reception device
20 Rocker
22 Covering
24 Flush mount box
26 Wall
28 Power connection
30 Double arrow

1. A method for the operation of a control unit for at least one electrical device, the control unit being operable in a recording mode and an operating mode,
wherein in the recording mode
time data including a point in time the at least one electrical device is operated is recorded
corresponding operating data are associated and saved with the time data corresponding to the point in time,
wherein the time data lie within a memory time interval,
wherein a switch time point is recorded at which the control unit is switched from the recording mode to the operating mode and a changeover time point within the memory time interval is assigned to said switch time point, and
wherein in the operating mode, said operating data and said saved data recorded in the recording mode are read and the at least one electrical device is operated, dependent on said operating data and said saved data recorded in the recording mode starting at the changeover time point.

2. The method according to claim 1, wherein the memory time interval is repeated when in the operating mode and the at least one electrical device is operated repeatedly, dependent on said operating data and said saved data recorded in the recording mode.

3. The method according to claim 1 wherein in the recording mode, said operating data and said saved data recorded in the recording mode are overwritten with further operating data and further time data if the length of time during which the control unit is run in the recording mode is longer than a length of the memory time interval.

4. The method according to claim 1 wherein control unit comprises several control elements, wherein the operating data of individual control elements of said several control elements are saved in separate memory devices when in the recording mode.

5. The method according to claim 1 wherein the control unit is switched separately to the recording mode or operating mode for each electrical device of said at least one electrical device that is to be operated.

6. A control unit for at least one electrical device which comprises
at least one control element for the operation of the at least one electrical device, and
an electric control system
that is configured to be operable in a recording mode and an operating mode,
wherein in the recording mode
time data including a point in time the at least one electrical device is operated is recorded
corresponding operating data are associated and saved with the time data corresponding to the point in time,
wherein the time data lie within a memory time interval,
wherein a switch time point is recorded at which the control unit is switched from the recording mode to the operating mode and a changeover time point within the memory time interval is assigned to said switch time point, and
wherein in the operating mode, said operating data and said saved data recorded in the recording mode are read and the at least one electrical device is operated, dependent on said operating data and said saved data recorded in the recording mode starting at the changeover time point.

7. The control unit according to claim 6, wherein the control unit comprises several control elements wherein each control element of said several control elements are configured to save operating data if the control unit is operated in the recording mode.

8. The control unit according to claim 7, wherein a memory device is assigned to said each control element to save the operating data of said each control element and the time data.

9. The control unit according to claim 7 wherein a switch element is arranged on said each control element, and wherein the control unit can be switched from the recording mode to the operating mode and vice-versa.

10. The control unit according to claim 9, further comprising a transmission and reception device assigned to said each control element for transmitting and receiving signals from one control element about the switch from the recording mode to the operating mode, and vice-versa, to all other control elements said several control elements.
